(19) United States
(12) Patent Application Publication
(10) Pub. No.: US 2013/0331251 A1
(43) Pub. Date: Dec. 12, 2013

(54) CENTRIFUGAL MACHINE

(71) Applicant: Hitachi Koki Co., Ltd., Tokyo (JP)

(72) Inventors: Hiroatsu TOI, Ibaraki (JP); Eiichi Fukuhara, Ibaraki (JP); Takato Komura, Ibaraki (JP)

(21) Appl. No.: 13/911,678

(22) Filed: Jun. 6, 2013

(30) Foreign Application Priority Data
Jun. 7, 2012 (JP) 2012-129840

(51) Int. Cl. B04B 9/10

(52) U.S. Cl. CPC B04B 9/10
USPC 494/9

(57) ABSTRACT

A centrifugal machine including: a rotor which is configured to accommodate a sample; a driving part which is configured to rotate the rotor; a control part which is configured to control the driving part; an operating part; and a record part, wherein the operating part is provided with a login screen to which first user information is configured to be inputted at the start of an operation, and a user change screen to which second user information different from the first user information inputted to the login screen is configured to be inputted, and wherein the record part is configured to record the first user information, the second user information, a change time at which the user information is changed, and a rotating speed of the rotor.

### CROSS-REFERENCE TO RELATED APPLICATIONS

This application claims priority from Japanese Patent Application No. 2012-129840 filed on Jun. 7, 2012, the entire contents of which are incorporated herein by reference.

### TECHNICAL FIELD

Aspects of the present invention relates to a centrifugal machine, and more particularly to a change of a user (an operator) during an operation thereof.

### BACKGROUND

As a kind of a centrifugal machine which carries out various kinds of processes by using a centrifugal force, there is a continuous centrifugal separator in which a sample is continuously supplied to centrifugally separate particles in the liquid sample in a rotor. The continuous centrifugal separator is widely used to separate the particles which do not precipitate or hardly precipitates in an ordinary gravity field and is widely used as a separating and purifying facility of, for instance, chemicals or vaccine.

In a continuous centrifugal separator used as a production facility of medical products, it is necessary to manage an operation record, and a “user” of the continuous centrifugal separator is also managed as one of the operation records.

As disclosed in JP-A-2007-130609 or JP-A-2001-104835, a validation method for validating a user of a centrifugal separator is proposed.

However, both JP-A-2007-130609 or JP-A-2001-104835 do not specifically consider a change of a user.

The continuous centrifugal separator may be sometimes operated for as long as ten to twelve hours in one operation. Accordingly, the operation of the continuous centrifugal separator may be started by a first user, and after a predetermined time elapses, there is a possibility that the operation is stopped by a second user different from the first user.

In such a case, since the user is changed during the operation, it is necessary to record the change in the user as the operation record of the continuous centrifugal separator.

Further, based on common sense, the user may carry out log in and log out operations each time when the user starts or stops the operation of the continuous centrifugal separator. However, when such a method is carried out, a situation occurs that the information is not recorded in the operation record even when the user is actually present during the operation of the continuous centrifugal separator.

Further, after the first user sets an operation parameter of the continuous centrifugal separator to start the operation, it is preferred to avoid the operation parameter from being changed by the second user.

### SUMMARY

The present invention is devised by considering the above-described circumstances and an object of the present invention to provide a centrifugal machine which can assuredly change a user during an operation and assuredly leave a record thereof.

According to an aspect of the present invention, there is provided a centrifugal machine including: a rotor which is configured to accommodate a sample; a driving part which is configured to rotate the rotor; a control part which is configured to control the driving part; an operating part as a user interface; and a record part which is configured to record at least a rotating speed of the rotor, wherein the operating part is provided with a login screen to which first user information is configured to be inputted at the start of an operation, and a user change screen to which second user information different from the first user information inputted to the login screen is configured to be inputted, and wherein the record part is configured to record the first user information, the second user information, and a change time at which the user information is changed, as well as the rotating speed of the rotor.

According to another aspect of the present invention, there is provided a centrifugal machine including: a rotor which is configured to accommodate a sample; a driving part which is configured to rotate the rotor; a control part which is configured to control the driving part; an operating part; and a record part which is configured to record at least a rotating speed of the rotor, wherein the operating part is configured to display a login screen which is configured to receive first user information at the start of an operation, and a user change screen which is configured to receive second user information different from the first user information received by the login screen, and wherein the record part is further configured to record the first user information, the second user information, and a change time at which the user information is changed from the first user information to the second user information.

According to the present invention, the user can be assuredly changed during the operation of the centrifugal machine and the record thereof can be assuredly left.

### BRIEF DESCRIPTION OF DRAWINGS

FIG. 1 is a perspective view of a continuous centrifugal separator as an exemplary embodiment of a centrifugal machine according to the present invention;

FIG. 2 is a sectional view of a centrifugal separating part in the continuous centrifugal separator;

FIG. 3 is an operation flowchart;

FIG. 4 is an explanatory view showing a login screen;

FIG. 5 is an explanatory view showing a user change screen;

FIG. 6 is an explanatory view showing an example of an audit trail record; and

FIG. 7 is an explanatory view showing an example of an operation record.

### DETAILED DESCRIPTION

Hereinafter, referring to the drawings, a preferred exemplary embodiment of the present invention will be described in detail. The same or equivalent component elements, members and processes respectively shown in the drawings are designated by the same reference numerals and a duplicated explanation will be suitably omitted. The exemplary embodiment does not limit the present invention, but shows an exemplification. All features described in the exemplary embodiment or a combination thereof does not necessarily show essentials of the present invention.

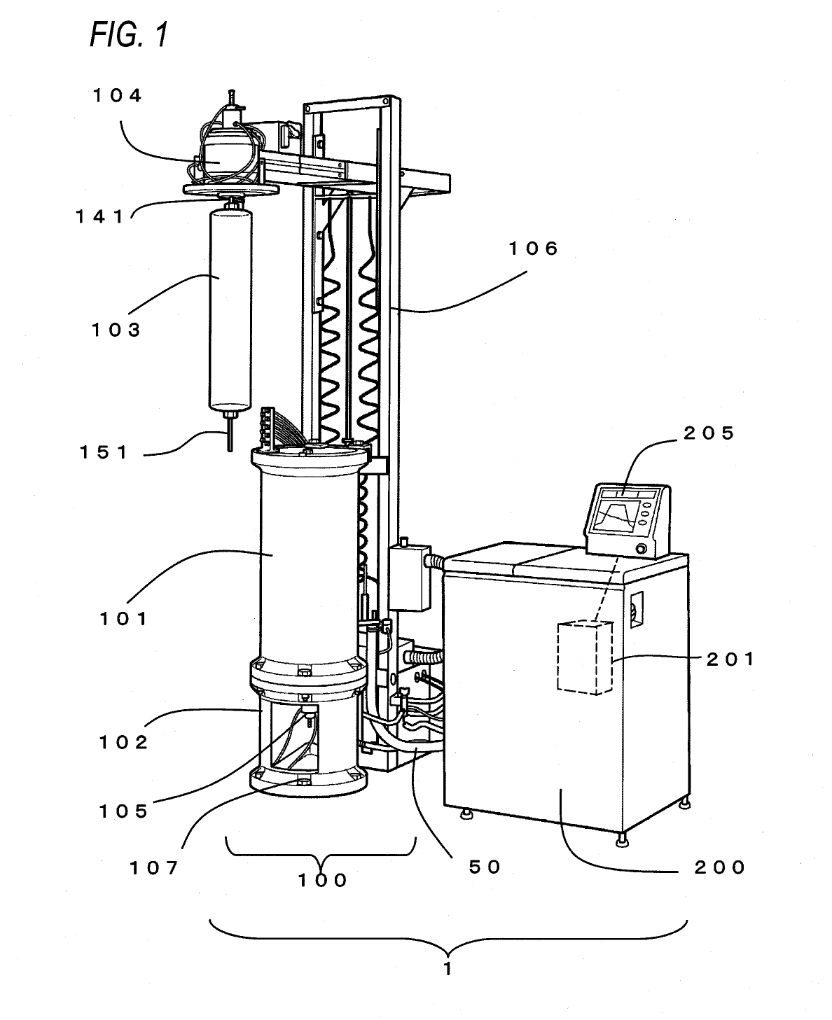

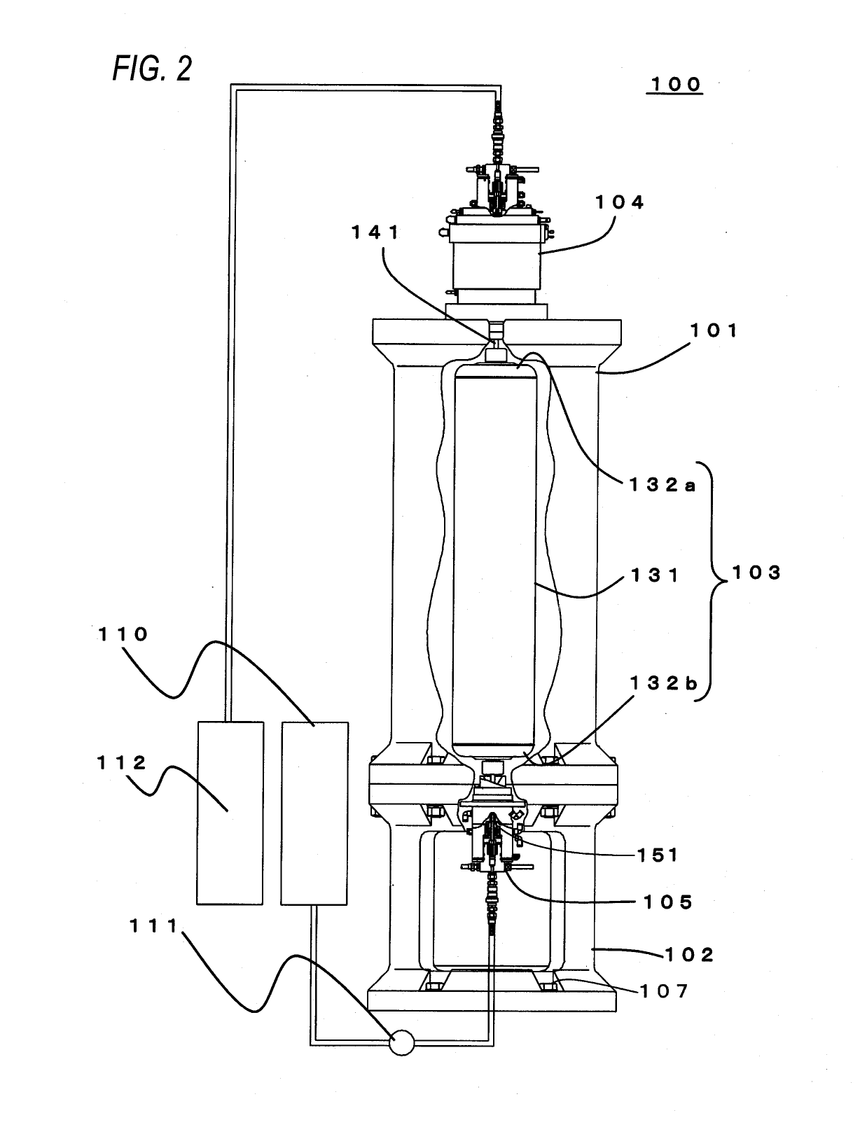

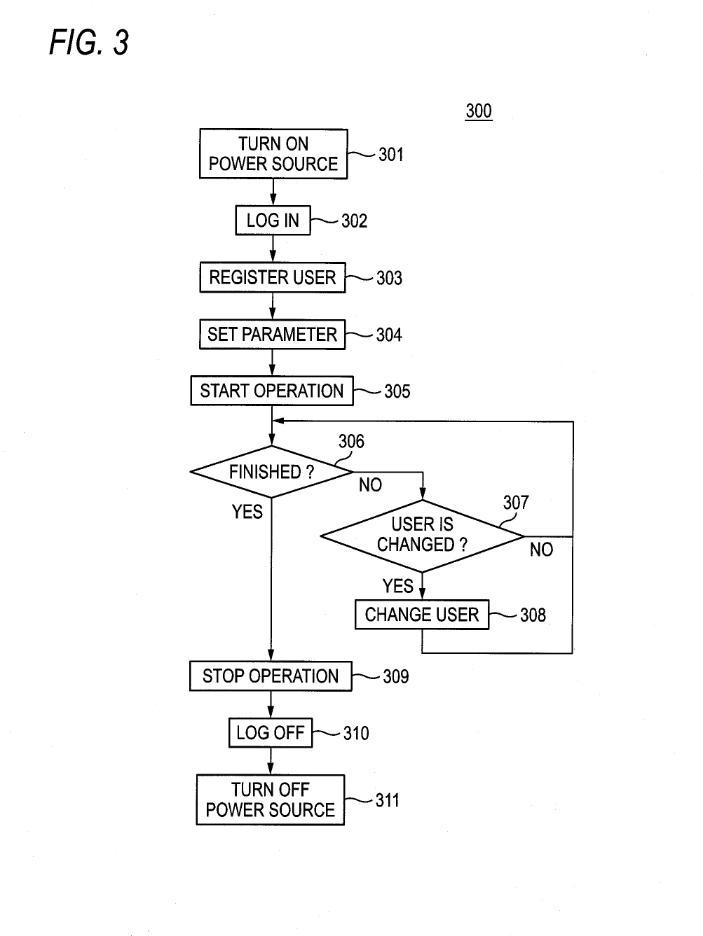

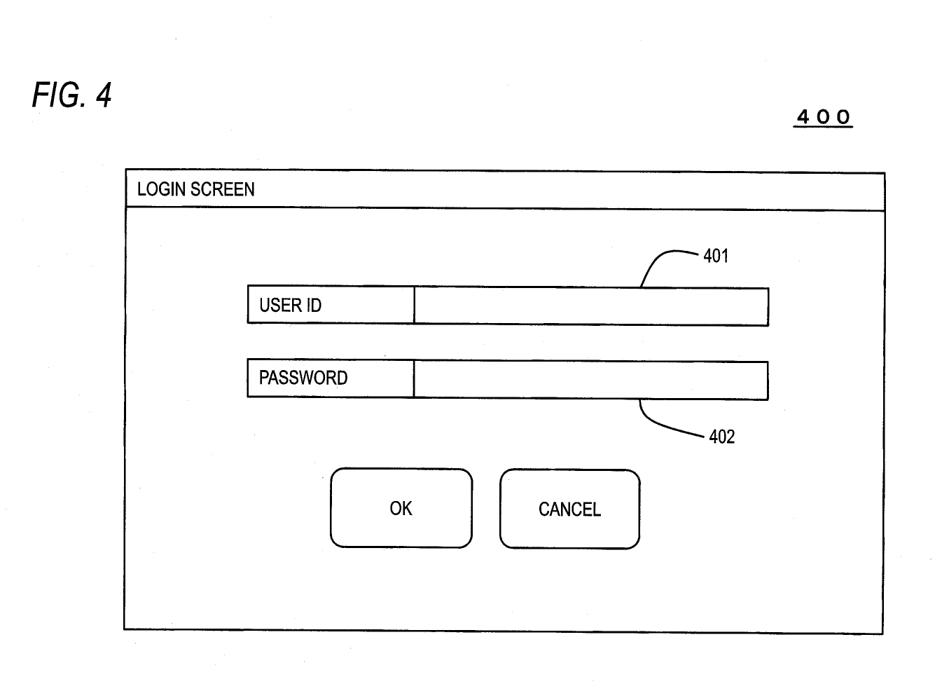

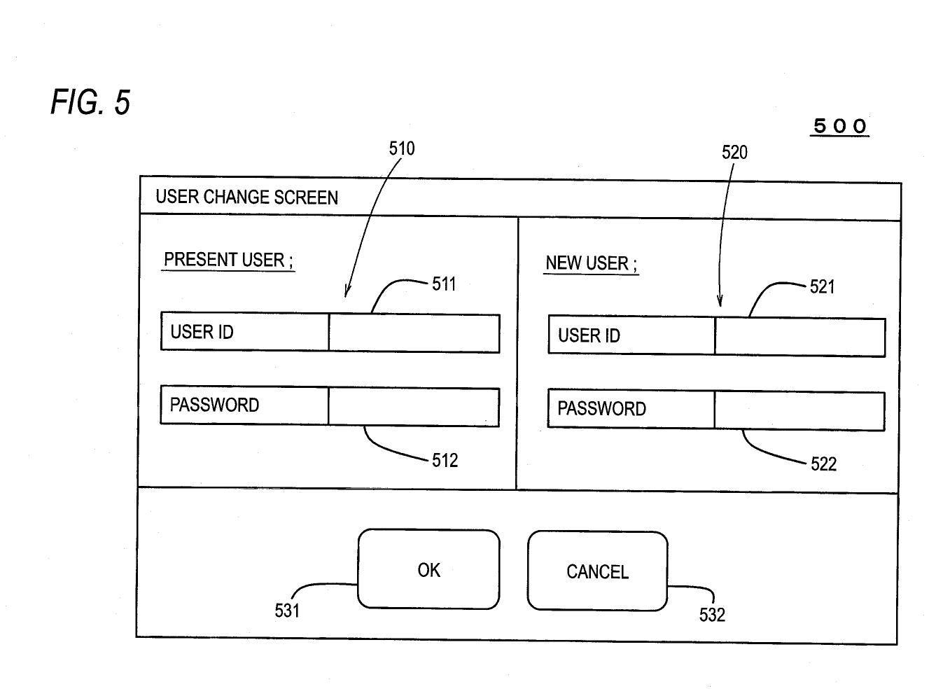

FIG. 1 is a perspective view showing an entire part of a continuous centrifugal separator 1 as a centrifugal machine according to the exemplary embodiment of the present invention. FIG. 2 is a sectional view of a centrifugal separating part 100. FIG. 3 is an operation flowchart. FIG. 4 shows a login screen. FIG. 5 shows a user change screen.

In FIG. 1, the continuous centrifugal separator 1 according to the present exemplary embodiment includes the centrifugal separating part 100 and a controller part 200. The centrifugal separating part 100 is connected to the controller part 200 by a group of wirings and piping 50.

The centrifugal separating part 100 includes a cylindrical chamber 101 as a centrifugal chamber, a base 102 which supports the chamber 101, a rotor 103 accommodated in the chamber 101 so as to be freely taken in and out and rotating at high speed, a driving part 104 arranged in an upper part of the chamber 101 to rotate and drive the rotor 103 under a state that the rotor 103 is hung down, a lower rotation support part 105 attached to a lower part of the chamber 101 and formed with a lower bearing part, and a lift 106 which moves the driving part 104 upward and downward, and forward and backward. In upper and lower parts in the axial direction of the rotor 103, an upper shaft 141 and a lower shaft 151 are provided which serve as two rotating shafts having through holes provided therein.

The controller part 200 includes a control part 201 which controls the rotation of the driving part 104 or a cooling unit which cools the rotor 103. In an upper part of the controller part 200, a control panel 205 is provided as an operating part of a user interface. The control panel 205 is electrically connected to the control part 201, is provided with an operating screen for setting operating parameters and has a function of inputting instructions of the operating parameters or displaying operating states. The control panel 205 may be, for instance, a touch panel type liquid crystal display. Further, the control panel 205 includes (can display) a login screen shown in FIG. 4 or a user change screen shown in FIG. 5, and it is possible to input user information, etc., to the screens.

FIG. 2 is a sectional view showing a detail of a structure of the centrifugal separating part 100. The centrifugal separating part 100 has a sample circulating unit including a sample tank 110 in which a liquid sample is stored, a sample supply pump 111 which injects the liquid sample held in the sample tank 110 to a centrifugal machine main body and a sample recovery tank 112 which recovers supernatant liquid discharged via the driving part 104 by a continuous centrifugal separation. Further, the centrifugal separating part 100 includes the chamber 101, the base 102 which holds the chamber 101, the driving part 104 and the lower rotation support part 105. The base 102 is fixed to a floor not shown in the drawing by bolts 107. In the vicinity of a center of an upper part of the base 102, a rotation support hole is formed, and the lower rotation support part 105 can be attached to the base 102 thereby.

The liquid sample put in the sample tank 110 is introduced into the rotor 103 via the lower shaft 151 from the lower rotation support part 105 by the sample supply pump 111 and is centrifugally separated by the rotor 103 rotating at high speed. The supernatant liquid collected in an inner side in the radial direction by the centrifugal separation passes through the driving part 104 via the upper shaft 141 and is recovered to the sample recovery tank 112. The sample supply pump 111 is connected to the below-described control part 201 by a signal line not shown in the drawing, and a supplying by the sample supply pipe 111 by the control part 201.

The rotor 103 includes a cylindrical rotor body 131 and upper and lower rotor covers 132a and 132b screwed and attached to upper and lower parts of the rotor body 131. Here, in axial centers of the upper and lower covers 132a and 132b, sample passing holes are respectively formed. The upper shaft 141 of the driving part 104 is attached to the rotor cover 132a. The lower shaft 151 of the lower rotation support part 105 is attached to the rotor cover 132b. The upper shaft 141 is rotated at a high speed by driving a motor included in the driving part 104, so that both the rotor 103 attached to the upper shaft 141 and the lower shaft 151 attached to the rotor 103 are rotated at a high speed.

Next, by referring to FIG. 3, a standard operation flow of the continuous centrifugal separator 1 will be described. Operations of hardware will be omitted, such as an assembly of the rotor 103, an attachment of the rotor 103 to the driving part 104, an attachment of the rotor to the chamber 101 and a supply of the sample liquid to the rotor 103 by the sample supply pump 111, which are necessary in an actual operation. Further, information of users who can use the continuous centrifugal separator 1 is supposed to be previously registered in a storage part (not shown in the drawing) implemented by, for example, a memory in the control part 201. An explanation of a registering method thereof will be also omitted.

Initially, when a power source of the continuous centrifugal separator 1 is turned on (301), the login screen shown in FIG. 4 is displayed on the control panel 205 (302). The user carries out a login operation in accordance with a below-described procedure so that the user is registered (303).

Then, by operating the control panel 205, the user sets the parameters such as a rotating speed, an operating time, a temperature of the rotor or the like of the continuous centrifugal separator 1 (304), and carries out an operation for starting the operation so as to rotate the rotor 103 (305).

Then, after the rotor 103 reaches a predetermined rotating speed, the sample to be separated is continuously supplied to the rotor 103 by the sample supply pump 111 until finish a predetermined operation, a decision of a completion of the operation is waited (306). The operating time of the continuous centrifugal separator 1 may possibly reach ten hours to twelve hours. Thus, the user is supposed to be changed during the operation (307). When changing the user (Y(YES) in the step 307), the user is changed by validating both an original user and a new user (who takes over the operation) by the user change screen shown in FIG. 5 (308).

As a matter of course, the users are supposed to be changed a plurality of times during one operation of the continuous centrifugal separator 1, and in this case, the users are changed each time.

When the operation is finished, a stop process is carried out by the operation of the user registered at present (309). After all the operations of the continuous centrifugal separator 1 are finished, a log off operation is carried out by the user registered at present (310). Subsequently, the power source is turned off (311) to finish all the operations.

Next, the login screen 400 will be described by using FIG. 4. The login screen 400 is a screen initially displayed in the control panel 205 after the power source of the continuous centrifugal separator 1 is turned on.

The user touches input columns of a user ID input column 401 and a password input column 402 to input a previously registered user ID and password, thereby carrying out a login operation. When the user information is correctly inputted, the operating screen (not shown in the drawing) is displayed in the control panel 205 so that the continuous centrifugal separator 1 can be operated.

Next, the user change screen 500 will be described by using FIG. 5. The user change screen 500 is a screen used when the present user is changed to a new different user during the operation of the continuous centrifugal separator 1.

The user change screen is formed with one screen. In a left side, an input column 510 of the user logged in at present is provided, and, in a right side, an input column 520 of the new user is provided. Further, in a lower part of the screen, an OK button 531 for changing the user, and a cancel button 532 used when not changing the user, are provided. The input column 510 of the user at present serves to notify the user to input the present user information and the password corresponding to the user information inputted to the login screen. The input column 520 of the new user serves to notify the user to input new user information and a password corresponding to the new user information.

When the user is changed, the present user initially inputs the user ID and the password of the user himself or herself in a user ID input column 511 and a password input column 512. Then, the new user inputs a user ID and a password of the user himself or herself in a user ID input column 521 and a password input column 522.

After the input column 510 of the user logged in at present and the input column 520 of the new user are completely filled, when the OK button 531 provided in the user change screen 500 is touched, the original user is changed to the new user under a condition that the user information and the passwords respectively correspond to the previously registered information of the users who can use the continuous centrifugal separator 1. Then, the change of the user to the new user and an operation record are stored in the storage part not shown in the drawing by the control part 201, and shifts to the operating screen (a validation by the first user and a validation by the second user are carried out). Although the user is not changed even though the user change screen 500 is started, by touching the cancel button 532, the display shifts to the operating screen while the user is unchanged from the present user.

Further, there is also a function for leaving the operation record of the continuous centrifugal separator 1 as an audit trail. The audit trail function includes at least the date and hour, contents of the operations and the information of the user. When the user is changed, the record thereof is left. The control panel 205 is electrically connected to the control part 201. The operations of the control panel 205 are respectively stored in the storage part not shown in the drawing by the control part 201. The operation record can be displayed in the control panel 205 if necessary.

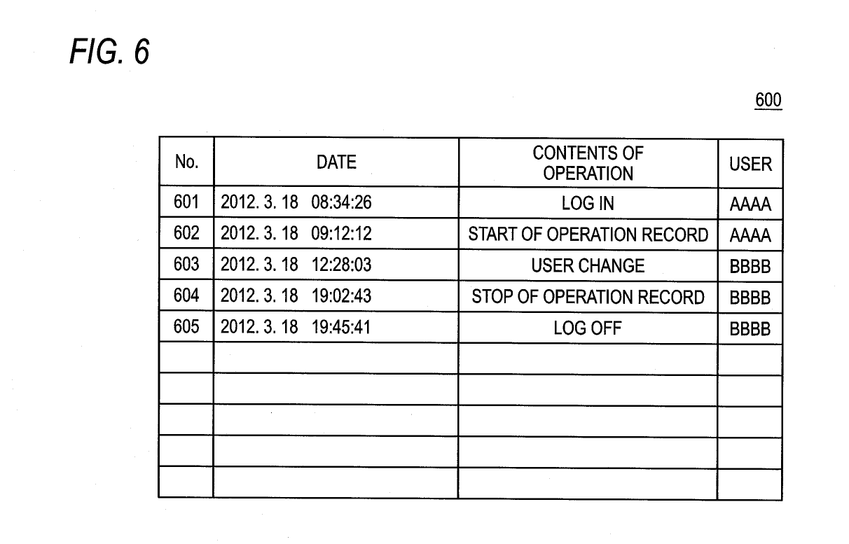

FIG. 6 shows an example of an audit trail record 600. The audit trail record shows that a login operation 601 and an operation record starting operation 602 are carried out by a user name “AAAA”, the user name is changed to a user name “BBBB” in a user change 603, and operations of an operation record stop 604 and a log off 605 are carried out by the user name “BBBB”. Further, the audit trail record shows times at which the operations are performed. The audit trail record shown in FIG. 6 may be generated by the control part 201 in accordance with the operation records of the control panel 205 and displayed in the control panel 205.

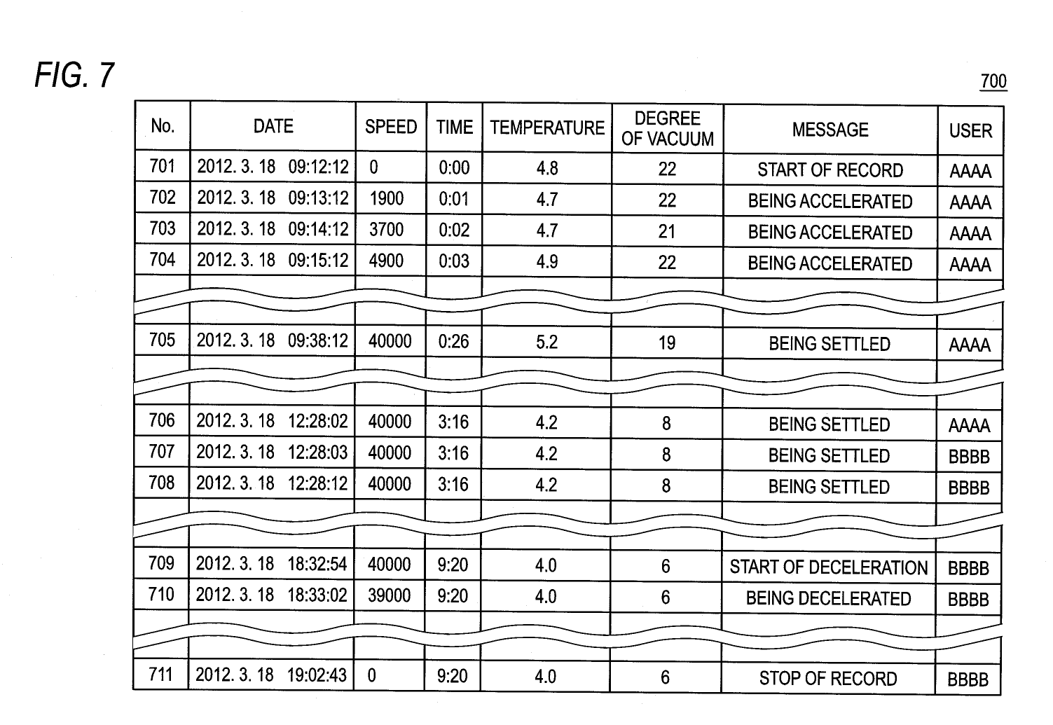

FIG. 7 shows an example 700 of the operation record. As compared with the audit trail record 600 which has a purpose of mainly leaving records of the operations of the continuous centrifugal separator 1, the operation record 700 serves to record the operating parameters during one operation including an acceleration and deceleration of the continuous centrifugal separator 1. For instance, by the control part 201, the record part (not shown in the drawing) records the user information together with the operating parameters including the rotating speed of the rotor for each of predetermined sampling periods during a period from a start of the rotation to an end of the rotation of the driving part.

The operation record shows that the operation record is started by the user AAAA (701), and the rotating speed is gradually accelerated (702 to 704), reaches to a previously set rotating speed (for instance, 40,000 min⁻¹) and is settled (705 to 706).

After 3 hours and 16 minutes, the user is changed from AAAA to BBBB (707). The operation record is left as a record showing that the user is BBBB from the settled state of the rotating speed (708), via a start of deceleration of the rotating speed (709) and the deceleration (710) till a stop of the operation record (711). The operation record shown in FIG. 7 can be generated by the control part 201 in accordance with the operation records or the measured values of the operating parameters of the control panel 205 and displayed in the control panel 205.

Next, the continuous centrifugal separator 1 when the user is changed will be described. In the continuous centrifugal separator 1, the operating parameters are set by the user at the time of starting the operation. In principle, the user who has changed during the operation is not supposed to change the operating parameters. Accordingly, when the user is changed, the new user is prohibited from changing the operating parameters (namely, to the users after the second user, a setting screen of the operating parameters is not displayed in the control panel 205.).

According to the present exemplary embodiment, the following effects can be achieved.

(1) The user can be assuredly changed during the operation of the continuous centrifugal separator 1 and the record thereof can be assuredly left.

(2) Since the user change screen shown in FIG. 5 requires the validation by the first user and the validation by the second user, the first user can be assuredly changed to the second user, so that an operation period during which the user is unknown does not exist.

(3) The control panel 205 is provided with the operating screen for setting the operating parameters including the rotating speed, the operating time and the temperature of the centrifugal machine. However, the control panel is set so that it is impossible for the second user to change the operating parameters set by the first user. Thus, an inconvenience can be prevented that the operating parameters are changed during the operation against an intention of the first user.

(4) When the user change is selected, since the control part 201 displays the screen to which the IDs and the passwords of the present user and the new user who took over the operation can be inputted in the control panel 205 at the same time, the user can be changed under an agreement between the present user and the new user. Accordingly, the user can be prevented from being arbitrarily changed to the new user.

The present invention has been described above based on the exemplary embodiment. However, it is to be understood to a person with ordinary skill in the art that the component elements or the processes of the exemplary embodiment may be respectively modified within a scope described in claims. Hereinafter, a modified example will be described.

In the above-described exemplary embodiment, the second user cannot change the parameters set by the first user. However, authority levels of users can be separated in order of low levels like an “ordinary user”, an “instructor” and a “supervisor”, and when the present user is changed to the user higher in authority level than the present user, the new user may be able to change operating parameters.

Further, in the exemplified user change screen, an input screen of the present user and the new user is formed by one screen. However, input screens of the present user and the new user may be separately displayed. For instance, when a user change is selected, a screen to which an ID and a password of the present user can be inputted may be initially displayed, and after the input by the present user has finished, a screen to which an ID and a password of the new user can be inputted may be displayed. When the input by the new user is finished, the user change may be completed.

The record of the change to the new user is stored in the storage part not shown in the drawing in the control part 201. However, the record of the change to the new user may be stored in an external storage device (a storage part) which can communicate with the centrifugal machine.

The present invention provides illustrative, non-limiting aspects as follows:

(1) In a first aspect, there is provided a centrifugal machine including: a rotor which is configured to accommodate a sample; a driving part which is configured to rotate the rotor; a control part which is configured to control the driving part; an operating part as a user interface; and a record part which is configured to record at least a rotating speed of the rotor, wherein the operating part is provided with a login screen to which first user information is configured to be inputted at the start of an operation, and a user change screen to which second user information different from the first user information inputted to the login screen is configured to be inputted, and wherein the record part is configured to record the first user information, the second user information, and a change time at which the user information is changed, as well as the rotating speed of the rotor.

(2) In a second aspect, there is provided a centrifugal machine according to the first aspect, wherein the operating part is provided with an operating screen at which operating parameters including a rotating speed, an operating time and a temperature of the centrifugal machine is configured to be set, and wherein the operating parameters cannot be changed after the user information has been changed.

(3) In a third aspect, there is provided a centrifugal machine according to the first or second aspect, wherein the record part is configured to record the user information together with the rotating speed of the rotor for each predetermined sampling period, during a period from a start of a rotation of the driving part to an end of the rotation of the driving part.

(4) In a fourth aspect, there is provided a centrifugal machine according to any one of the first to third aspects, wherein the user change screen is configured to notify input of the first user information and a password corresponding to the first user information inputted to the login screen, and configured to notify input of the second user information and a password corresponding to the second user information, and wherein the record part becomes allowed to record the second user information if each user information and each password is respectively validated.

(5) In a fifth aspect, there is provided a centrifugal machine including: a rotor which is configured to accommodate a sample; a driving part which is configured to rotate the rotor; a control part which is configured to control the driving part; an operating part; and a record part which is configured to record at least a rotating speed of the rotor, wherein the operating part is configured to display a login screen which is configured to receive first user information at the start of an operation, and a user change screen which is configured to receive second user information different from the first user information received by the login screen, and wherein the record part is further configured to record the first user information, the second user information, and a change time at which the user information is changed from the first user information to the second user information.

(6) In a sixth aspect, there is provided a centrifugal machine according to the fifth aspect, wherein the operating part is further configured to display an operating screen which is configured to receive operating parameters including a rotating speed, an operating time and a temperature of the centrifugal machine, and wherein the operating part is configured to prohibit displaying the operating screen after the user information is changed from the first user information to the second user information.

(7) Ina seventh aspect, there is provided A centrifugal machine according to the fifth or sixth aspect, wherein the record part is configured to record the user information together with the rotating speed of the rotor for each predetermined sampling period, during a period from a start of a rotation of the driving part to an end of the rotation of the driving part.

(8) In an eighth aspect, there is provided a centrifugal machine according to any one of the fifth to seventh aspects, wherein the user change screen is further configured to receive the first user information, a password corresponding to the first user information, and a password corresponding to the second user information, and wherein the record part is configured to record the second user information if both the password corresponding to the first user information and the password corresponding to the second user information are validated.

An arbitrary combination of the above-described component elements and a change of an expression of the present invention in a method or a system are also effectively used as forms of the present inventions.

What is claimed is:

1. A centrifugal machine comprising:
a rotor which is configured to accommodate a sample;
a driving part which is configured to rotate the rotor;
a control part which is configured to control the driving part;
an operating part as a user interface; and
a record part which is configured to record at least a rotating speed of the rotor,
wherein the operating part is provided with a login screen to which first user information is configured to be inputted at the start of an operation, and a user change screen to which second user information different from the first user information inputted to the login screen is configured to be inputted, and
wherein the record part is configured to record the first user information, the second user information, and a change time at which the user information is changed, as well as the rotating speed of the rotor.

2. A centrifugal machine according to claim 1,
wherein the operating part is provided with an operating screen at which operating parameters including a rotating speed, an operating time and a temperature of the centrifugal machine is configured to be set, and
wherein the operating parameters cannot be changed after the user information has been changed.

3. A centrifugal machine according to claim 1,
wherein the record part is configured to record the user information together with the rotating speed of the rotor for each predetermined sampling period, during a period from a start of a rotation of the driving part to an end of the rotation of the driving part.

4. A centrifugal machine according to claim 1,
wherein the user change screen is configured to notify input of the first user information and a password corresponding to the first user information inputted to the login screen, and configured to notify input of the second user information and a password corresponding to the second user information, and
wherein the record part becomes allowed to record the second user information if each user information and each password is respectively validated.

5. A centrifugal machine comprising:
a rotor which is configured to accommodate a sample;
a driving part which is configured to rotate the rotor;
a control part which is configured to control the driving part;
an operating part; and
a record part which is configured to record at least a rotating speed of the rotor,
wherein the operating part is configured to display a login screen which is configured to receive first user information at the start of an operation, and a user change screen which is configured to receive second user information different from the first user information received by the login screen, and
wherein the record part is further configured to record the first user information, the second user information, and a change time at which the user information is changed from the first user information to the second user information.

6. A centrifugal machine according to claim 5,
wherein the operating part is further configured to display an operating screen which is configured to receive operating parameters including a rotating speed, an operating time and a temperature of the centrifugal machine, and
wherein the operating part is configured to prohibit displaying the operating screen after the user information is changed from the first user information to the second user information.

7. A centrifugal machine according to claim 5,
wherein the record part is configured to record the user information together with the rotating speed of the rotor for each predetermined sampling period, during a period from a start of a rotation of the driving part to an end of the rotation of the driving part.

8. A centrifugal machine according to claim 5,
wherein the user change screen is further configured to receive the first user information, a password corresponding to the first user information, and a password corresponding to the second user information, and
wherein the record part is configured to record the second user information if both the password corresponding to the first user information and the password corresponding to the second user information are validated.
